(19) United States
(12) Patent Application Publication
(10) Pub. No.: US 2009/0056539 A1
(43) Pub. Date: Mar. 5, 2009

(54) AIR PURIFYING DEVICE

(75) Inventor: John R. Garrett, Vero Beach, FL (US)

Correspondence Address: DOVAS LAW P.C., 307 BAINBRIDGE STREET, PHILADELPHIA, PA, 19147, US

(73) Assignee: AirGorilla Corporation, Vero Beach, FL (US)

(21) Appl. No.: 12/199,442

(22) Filed: Aug. 27, 2008

Related U.S. Application Data
(60) Provisional application No. 60/968,281, filed on Aug. 27, 2007.

(51) Int. Cl. B03C 3/34

(52) U.S. Cl. 95/81; 96/16

(57) ABSTRACT

An air purifying device including a mounting body configured for connection to a duct or plenum of an air handling system is provided. The mounting body includes a substantially planar surface for removable connection to an ultraviolet illumination device. An aperture is provided through the substantially planar surface of the mounting body for passing an ultraviolet lamp of the ultraviolet illumination device through the mounting body. A low-profile porous substrate including a photocatalyst is connected to and extends from the mounting body. Further provided is a combination air purifying device and ultraviolet illumination device and a method of purifying air within an air handling system.

### CROSS REFERENCE TO RELATED APPLICATION(S)

This application claims the benefit of U.S. Provisional Patent Application No. 60/968,281, filed Aug. 27, 2007, which is incorporated by reference as if fully set forth.

### BACKGROUND

The air within our living and working environments may include several types of harmful contaminates including particles, organic and inorganic gases, and bioaerosols such as bacteria, viruses and molds. Ultraviolet air purifiers may be used to remove some of these contaminates from the air. Such devices typically use ultraviolet light to convert contaminates into less harmful or completely benign substances.

Known ultraviolet air purifiers may be used in an enclosed environment to provide effective air purification to promote the health of building occupants. These known devices are often difficult to install requiring special tools or special skills. Moreover, ultraviolet air purifiers include ultraviolet lamps which must be periodically replaced. Known devices often require tools or special skills for lamp replacement making such replacement especially inconvenient and the types of lamps useable with such known devices may be limited

In view of the above, it would be desirable to provide an ultraviolet air purifying device which can be easily integrated with existing air handling systems to provide effective air purification. Such system should also be easily integrateable with new air handling systems using conventional methods of air handling system design. Such system should allow for fast and convenient lamp replacement without the use of special tools or skills and be compatible with different types of ultraviolet lamps to accommodate a user's lamp preference.

### SUMMARY

The present invention provides an air purifying device including a mounting body configured for connection to a duct or plenum of an air handling system. The mounting body includes a substantially planar surface for removable connection to an ultraviolet illumination device. An aperture is provided through the substantially planar surface of the mounting body for passing an ultraviolet lamp of the ultraviolet illumination device through the mounting body. A low-profile porous substrate including a photocatalyst is connected to and extends from the mounting body.

The present invention further provides a combination air purifying device and ultraviolet illumination device. The combination device includes an air purifying device including a mounting body configured for connection to a duct or a plenum of an air handling system. The mounting body includes a substantially planar surface and an aperture through the substantially planar surface. The air purifying device further includes a low-profile porous substrate having a photocatalyst connected to and extending from the mounting body. The combination device further includes an ultraviolet illumination device comprising a mounting flange removably connected to the substantially planar surface of the mounting body of the air purifying device and an ultraviolet lamp extending from the mounting flange through the aperture of the air purifying device.

The present invention further provides a method of purifying air within an air handling system. The method includes providing an air purifying device including a mounting body which includes a substantially planar surface and an aperture, and including a low-profile porous substrate having a photocatalyst connected to and extending from the mounting body. An ultraviolet illumination device is provided including a mounting flange and an ultraviolet lamp connected to and extending from the mounting flange. The mounting body of the air purifying device is connected to a duct or plenum of an air handling system, and the low-profile porous substrate is positioned within an air flow path of the air handling system. The mounting flange of the ultraviolet illumination device is connected to the substantially planar surface of the mounting body of the air purifying device, and the ultraviolet lamp is passed through the aperture within the air flow path of the air handling system. A flow of air is provided through the air flow path of the air handling system, and the ultraviolet lamp is illuminated.

### BRIEF DESCRIPTION OF THE DRAWING(S)

The foregoing Summary as well as the following detailed description will be readily understood in conjunction with the appended drawings which illustrate preferred embodiments of the invention. In the drawings:

FIG. 1 is a front perspective view of an air purifying device according to a first preferred embodiment of the present invention.

FIG. 2 is a side elevation view of the air purifying device of FIG. 1.

FIG. 3 is a rear elevation view of the air purifying device of FIG. 1 taken along line 3-3 of FIG. 2.

FIG. 4 is an exploded front perspective view of an assembly including the air purifying device of FIG. 1, an ultraviolet illumination device, and an air duct.

FIG. 5 is a front elevation view showing the assembly of FIG. 4 including the air purifying device of FIG. 1 and the ultraviolet illumination device of FIG. 4 connected to the air duct of FIG. 4.

FIG. 6 is a cross-section view taken along line 6-6 of FIG. 5 showing the assembly of FIG. 4 including the air purifying device of FIG. 1 and the ultraviolet illumination device of FIG. 4 connected to the air duct of FIG. 4.

FIG. 7 is a front perspective view of an air purifying device according to a second preferred embodiment of the present invention.

FIG. 8 is a side elevation view of the air purifying device of FIG. 7.

FIG. 9 is a rear elevation view of the air purifying device of FIG. 7 taken along line 9-9 of FIG. 8.

FIG. 10 is a front perspective view of an air purifying device according to a third preferred embodiment of the present invention.

FIG. 11 is a side elevation view of the air purifying device of FIG. 10.

FIG. 12 is a rear elevation view of the air purifying device of FIG. 10 taken along line 12-12 of FIG. 11.

FIG. 13 is a flow chart showing a method of purifying air within an air handling system according to a preferred embodiment of the present invention

### DETAILED DESCRIPTION OF THE PREFERRED EMBODIMENT(S)

Certain terminology is used in the following description for convenience only and is not limiting. The words “right,” “left,” “top,” and “bottom” designate directions in the drawings to which reference is made. The words “a” and “one” are defined as including one or more of the referenced item unless specifically stated otherwise. This terminology includes the words above specifically mentioned, derivatives thereof, and words of similar import. The phrase “at least one” followed by a list of two or more items, such as A, B, or C, means any individual one of A, B or C as well as any combination thereof.

The preferred embodiments of the present invention are described below with reference to the drawing figures where like numerals represent like elements throughout.

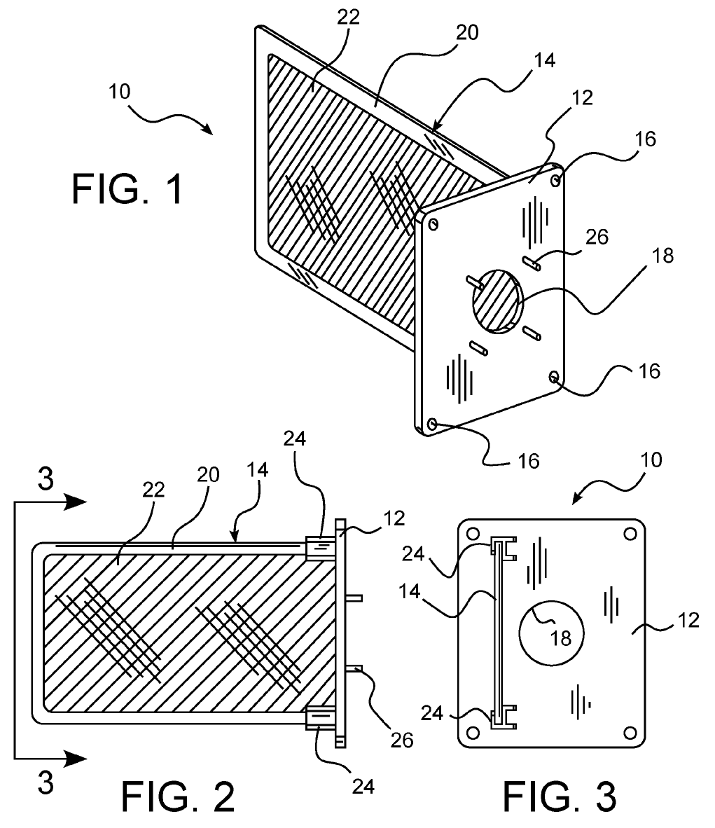

Referring to the FIGS. 1-3, an air purifying device 10 according to a first preferred embodiment of the present invention is shown. The air purifying device 10 includes a mounting body 12 configured for connection to a duct or a plenum of an air handling system such as a residential or commercial HVAC system. A low-profile porous substrate 14 including a photocatalyst is connected to and extends from the mounting body 12.

The mounting body 12 is preferably formed of plate material, and more preferably formed of ferromagnetic metallic plate material such as steel plate. Alternatively, the mounting body 12 may be formed of any suitable ferromagnetic or non-ferromagnetic material including aluminum or suitable polymeric materials. The mounting body 12 includes mounting holes 16 to facilitate attachment to a duct or plenum of an air handling system, for example via screws, rivets, or other fastening devices. Alternatively, the mounting body 12 can be configured for connected in any suitable manner to an air handling system within an air flow path. An aperture 18 is provided in the mounting body 12 for receiving therethrough an ultraviolet lamp of a suitable ultraviolet illumination device.

As shown, the low-profile porous substrate 14 is rectangular and substantially flat and planar and includes a filter portion 22. The filter portion 22 preferably includes one or more of a perforated plate, grid, screen, mesh or other porous construction to allow through passage of a flow of air. A frame 20 is preferably provided to provide rigidity to the porous substrate 14. The porous substrate 14 preferably includes a large surface area as a result of surface unevenness, irregularities or the like of the filter portion 22, such that a substantial amount of photocatalyst may be exposed. The substrate 14 extends, as shown, substantially perpendicular from the surface of the mounting body 12, and is held in place by mounting tracks 24 which are permanently affixed to the mounting body 12. Alternatively, the substrate 14 may extend approximately perpendicularly from the surface of the mounting body 12, for example at any suitable angle between about 70 degrees and 110 degrees from a surface of the mounting body 12. Alternatively, the low-profile porous substrate 14 may have an arced or bent form for example to provide structural rigidity or desired air flow properties within a duct or plenum, and further may be configured in a suitable shape other than rectangular, for example circular or irregularly shaped.

Preferably, a height of the substrate 14, defined by an edge of the substrate 14 adjacent to the mounting body 12, is at least 75 percent a length of the mounting body, such that in an installed position in a section of a flow path of a duct or plenum, the substrate 14 encompasses a significant portion of the flow area of the flow path in the section. Preferably, the substrate 14 through its porosity is configured to provide ample air through flow to minimize pressure drop when installed in a duct or plenum of an air handling system.

The substrate 14 is constructed of one or more suitable porous materials, preferably residing in the filter portion 22, capable of receiving or being formed integral with the photocatalyst. The substrate 14 is firmly connected to the mounting body 12 to prevent breakage from handling or from the passage of high speed air flow. The frame 20 is preferably provided to support the substrate 14 and to engage the mounting tracks 24, as shown, allowing for less rigid materials, such as mesh or screen materials of metallic or polymeric construction in the filter portion 22, to be used in forming the substrate 14. The photocatalyst preferably includes titanium dioxide which is coated onto the substrate 14 or portions of the substrate 14 including the filter portion 22. Alternatively, any photocatalyst suitable for activation by an ultraviolet light source may be applied to the substrate 14 or otherwise formed integrally with the substrate 14.

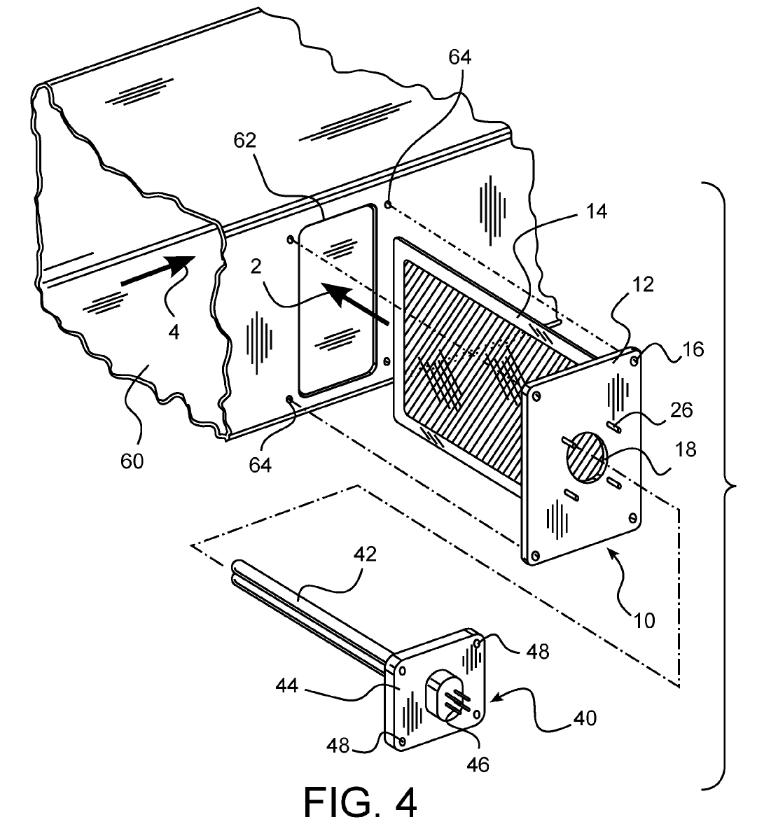

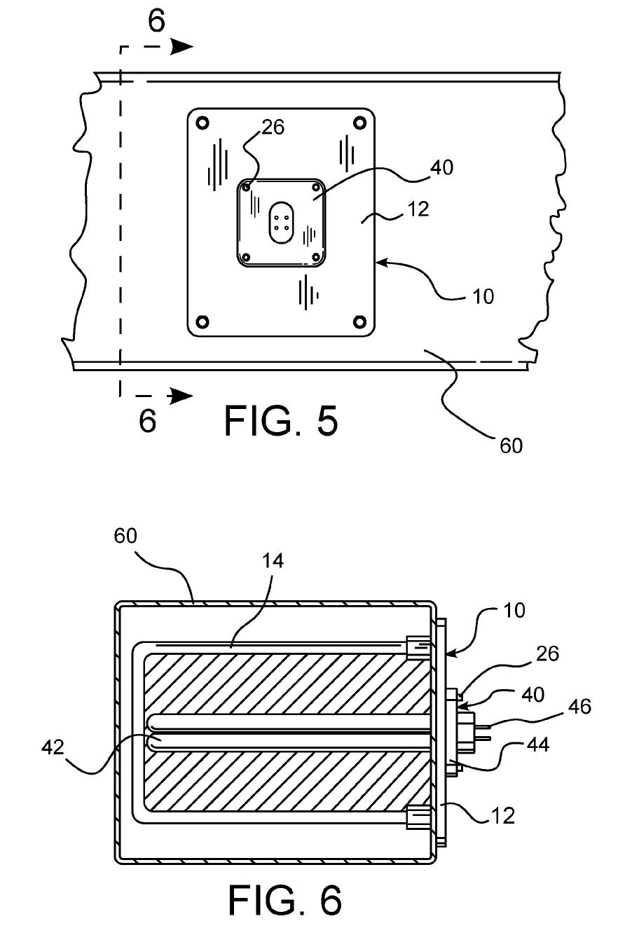

The air purifying device 10 is configured for connection both to an air duct or plenum and to an ultraviolet illumination device of a type having an ultraviolet lamp able to pass through the aperture 18 of the mounting body 12. Referring to FIGS. 4-6, an assembly according to a preferred embodiment of the invention including the air purifying device 10, an ultraviolet illumination device 40, and an air duct 60 is shown. The air purifying device 10 may be connected to air ducts or plenums of any suitable shape and flow path cross-sectional area within new or pre-existing air handling systems. A clearance opening 62 is created in the duct 60 to permit passage of the substrate 14 and the ultraviolet illumination device 40 therethrough. Holes 64 may also be created in the duct 60 in alignment with the mounting holes 16 in the mounting body 12 to facilitate connecting the air purifying device 10 to the air duct 60 via mechanical fasteners. The mounting body 12 attaches substantially flush with a surface of the air duct 60 to prevent escape of a significant amount of air from the air flow path of the air duct or plenum through edges of the mounting body 12. Gaskets, caulking, adhesive tape or other means may be used to prevent air from escaping through edges of the mounting body 12.

The ultraviolet illumination device 40 includes an ultraviolet lamp 42 which passes through the aperture 18 of the mounting body 12 when the ultraviolet illumination device 40 is connected to the air purifying device 10. Electrical connector 46 provides a path to supply power to the ultraviolet lamp 42. A mounting flange 44 is configured for attachment to the mounting body 12 of the air purifying device 10. The mounting flange 44 is preferably connected using nuts or other suitable threaded fasteners which attach to threaded studs 26 extending from the mounting body 12 through mounting holes 48 on the mounting flange 44. Alternatively, the mounting flange 44 may be connected to the mounting body 12 in any suitable manner including using screws, clips, rivets, permanent magnets, or using an adhesive, but it is preferred that the ultraviolet illumination device 40 is attached to the air purifying device 10 in a removable manner to facilitate replacement and servicing of the ultraviolet illumination device 40. It is further preferred that the mounting flange 44 is attached generally flush with the mounting body 12 to provide an adequate seal between the mounting flange 44 and the mounting body 12 to prevent a significant amount of air from escaping a duct or plenum on which the air purifying device 10 is attached. Gaskets, caulking, adhesive tape or other suitable means may be used to further decrease escaping of air between the mounting flange 44 and the mounting body 12. The form of the ultraviolet air purifying device 40 is not limiting, and any ultraviolet air purifying device having a mounting flange configured to mount generally flush with a corresponding mounting body may be used.

The ultraviolet lamp 42 of the illumination device 40 is preferably, as shown, elongated and positioned adjacent to a planar surface of the low-profile porous substrate 14 substantially, or alternatively approximately, perpendicular to a surface of the mounting body 12 for activating the photocatalyst by ultraviolet irradiation. The aperture 18 in the mounting body is preferably suitably spaced from the low-profile porous substrate such that the ultraviolet lamp 42 is suitably spaced from the low-profile porous substrate 14 to allow sufficient irradiation of an entire surface of the low-profile porous substrate 14. The ultraviolet lamp 42 preferably emits relatively intense radiation at a wavelength of about 254 nm, which corresponds to the wavelength commonly known as germicidal. More preferably, the ultraviolet lamp 42 emits relatively intense radiation across a broad spectrum of wavelengths between 200 nm and 300 nm. Alternatively, the ultraviolet lamp 42 may further emit radiation at ozone-generating wavelengths including wavelengths less than 200 nm, such as an ideal ozone-generating wavelength of about 185 nanometers. As shown in FIG. 4, the aperture 18 and the ultraviolet lamp 42 are preferably positioned upstream from the substrate 30 when installed in an air flow path of an air handling system, the direction of air flow in the assembly of FIG. 4 being indicated by the arrow 4.

While not wishing to be bound by any particular theory of functionality, the elongated shape of the ultraviolet lamp 42 and its position in proximity to the substrate 14 permits superior activation of the photocatalyst on the substrate 14, creating oxygen-containing radicals for oxidizing harmful contaminates, without significantly hindering air flow through an air handling system in which the air purifying device 10 is installed. Its relatively large surface area permits the substrate 14 to encompass a significant portion of a flow area of a flow path in a section in which it is installed, resulting in effective treatment of air passing therethrough. Moreover, the ultraviolet radiation is emitted by the ultraviolet lamp 42 in all directions around the lamp 42, including upstream and downstream of a flow path in which the air purifying device 10 is installed. As such, the ultraviolet lamp 42 alone provides a level of germicidal disinfection of a passing airflow, complementing the oxidization of harmful contaminates stimulated by the photocatalyst, especially in the case where the ultraviolet lamp 42 is configured for emitting a broad spectrum of wavelengths between 200 nm and 300 nm suitable for disinfection and germicidal functionality.

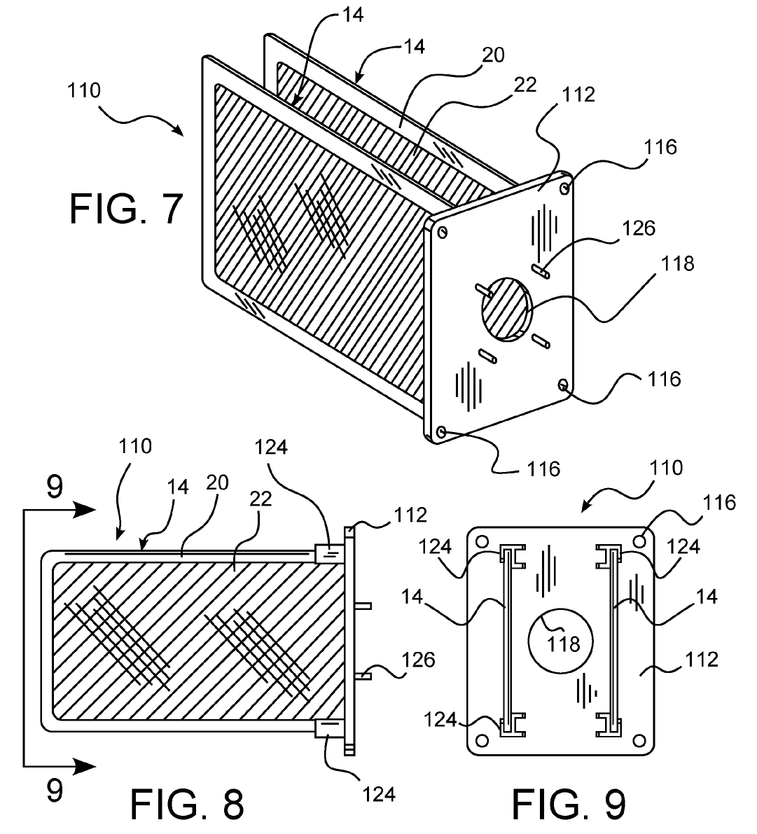

Referring to FIGS. 7-9, an air purifying device 110 according to a second preferred embodiment of the present invention is shown. The air purifying device 110 includes a mounting body 112 having mounting holes 116 to facilitate connection to a duct or a plenum of an air handling system within an airflow path. Two low-profile porous substrates 14 including a photocatalyst are connected to and extend from the mounting body 112 via mounting tracks 124. An ultraviolet illumination device may be connected to the air purifying device 110, preferably via mounting studs 126 attached to the mounting body 112, in a manner shown in FIGS. 4-6 with respect to the air purifying device 10 according to the first preferred embodiment of the present invention. An ultraviolet lamp of an ultraviolet illumination device may be positioned through the aperture 118 between the two low-profile porous substrates 14 for irradiating opposing surfaces of the two low-profile porous substrates 14.

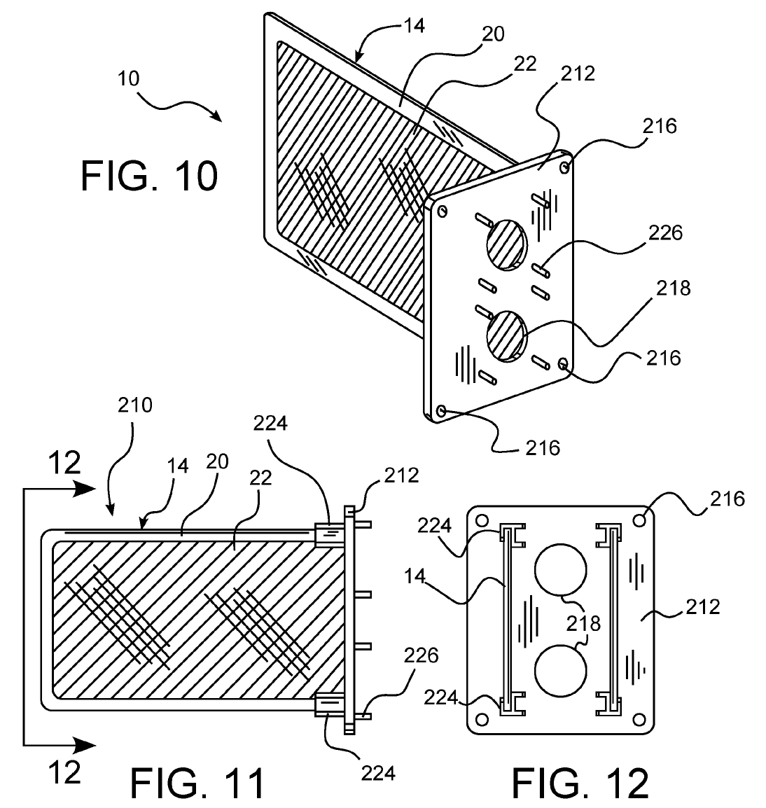

Referring to FIGS. 10-12, an air purifying device 210 according to a third preferred embodiment of the present invention is shown. The air purifying device 210 includes a mounting body 212 having mounting holes 216 to facilitate connection to a duct or a plenum of an air handling system within an airflow path. A low-profile porous substrate 14 including a photocatalyst is connected to and extends from the mounting body 212 via mounting tracks 224. Two ultraviolet illumination devices of the ultraviolet illumination devices may be connected to the air purifying device 210, preferably via mounting studs 126 attached to the mounting body 212, in a manner shown in FIGS. 4-6 with respect to the air purifying device 10 according to the first preferred embodiment of the present invention. Two ultraviolet lamps of the ultraviolet illumination devices may be positioned through respective ones of the two apertures 218 for irradiating the low-profile porous substrate 14. By providing two ultraviolet illumination devices with corresponding ultraviolet lamps, the substrate 14 is effectively radiated from multiple directions, decreasing the amount of photocatalyst which is non-activated due to surface shadows on the substrate 14, for example surface shadows caused by surface roughness of a mesh substrate.

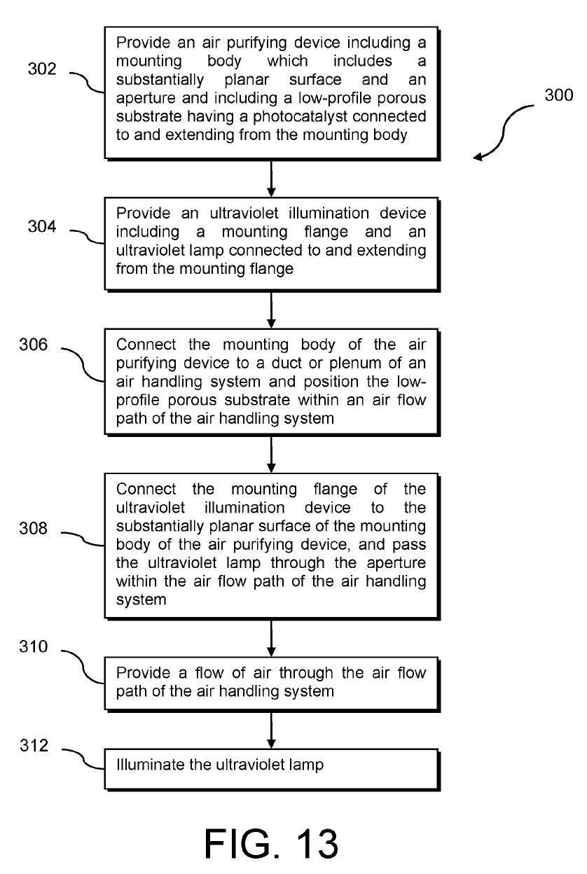

Referring to FIG. 13, a flow chart shows a method 300 of purifying air within an air handling system according to a preferred embodiment of the present invention. The method 300 includes providing an air purifying device including a mounting body which includes a substantially planar surface and an aperture and including a low-profile porous substrate having a photocatalyst connected to and extending from the mounting body (step 302). An ultraviolet illumination device is provided including a mounting flange and an ultraviolet lamp connected to and extending from the mounting flange (step 304). The mounting body of the air purifying device is connected to a duct or plenum of an air handling system, and the low-profile porous substrate is positioned within an air flow path of the air handling system (step 306). The mounting flange of the ultraviolet illumination device is connected to the substantially planar surface of the mounting body of the air purifying device, and the ultraviolet lamp is passed through the aperture within the air flow path of the air handling system (step 308). A flow of air is provided through the air flow path of the air handling system (step 310), and the ultraviolet lamp is illuminated (step 312).

While the preferred embodiments of the invention have been described in detail above, the invention is not limited to the specific embodiments described above, which should be considered as merely exemplary. Further modifications and extensions of the present invention may be developed, and all such modifications are deemed to be within the scope of the present invention as defined by the appended claims.

What is claimed is:

1. An air purifying device comprising:
a mounting body configured for connection to at least one of a duct and a plenum of an air handling system, the mounting body comprising a substantially planar surface for removable connection to an ultraviolet illumination device and at least one aperture through the substantially planar surface of the mounting body for passing an ultraviolet lamp of the ultraviolet illumination device through the mounting body; and
at least one low-profile porous substrate comprising a photocatalyst connected to and extending from the mounting body.

2. The air purifying device of claim 1, wherein the at least one low-profile porous substrate is substantially flat and planar.

3. The air purifying device of claim 2, wherein the mounting body is configured for positioning the low-profile porous substrate approximately perpendicular to a direction of air flow through the at least one of the duct and the plenum.

4. The air purifying device of claim 2, wherein the at least one aperture comprises a first aperture and a second aperture, wherein the first aperture and the second aperture are approximately equidistant from the low-profile porous substrate.

5. The air purifying device of claim 1, wherein a height of the porous substrate, defined by an edge of the porous substrate adjacent to the mounting body, is at least 75% a length of the mounting body.

6. The air purifying device of claim 1, wherein the photocatalyst comprises a coating of titanium dioxide on the low-profile porous substrate.

7. The air purifying device of claim 1, wherein the mounting body comprises a mounting plate, and wherein the at least one low-profile porous substrate extends approximately perpendicular from a surface of the mounting plate.

8. The air purifying device of claim 1, wherein the at least one low-profile porous substrate is removably connected to the mounting body.

9. The air purifying device of claim 1, wherein the at least one low-profile porous substrate comprises a first substantially planar porous substrate and a second substantially planar porous substrate, wherein the first substantially planar porous substrate and the second substantially planar porous substrate are approximately parallel, and wherein the at least one aperture is positioned through the mounting body between the first substantially planar porous substrate and the second substantially planar porous substrate.

10. A combination air purifying device and ultraviolet illumination device comprising:
an air purifying device comprising:
a mounting body configured for connection to at least one of a duct and a plenum of an air handling system, the mounting body comprising a substantially planar surface and at least one aperture through the substantially planar surface; and
at least one low-profile porous substrate comprising a photocatalyst connected to and extending from the mounting body; and
at least one ultraviolet illumination device comprising a mounting flange removably connected to the substantially planar surface of the mounting body of the air purifying device and an ultraviolet lamp extending from the mounting flange through the at least one aperture of the air purifying device.

11. The combination air purifying device and ultraviolet illumination device of claim 10, wherein the at least one low-profile porous substrate comprises a first substantially planar porous substrate and a second substantially planar porous substrate, wherein the first substantially planar porous substrate and the second substantially planar porous substrate are approximately parallel, wherein the at least one aperture is positioned through the mounting body between the first substantially planar porous substrate and the second substantially planar porous substrate, and wherein the ultraviolet lamp extends between the first substantially planar porous substrate and the second substantially planar porous substrate.

12. The combination air purifying device and ultraviolet illumination device of claim 10, wherein the mounting body of the air purifying device comprises a mounting plate, and wherein the at least one low-profile porous substrate extends approximately perpendicular from a surface of the mounting plate.

13. The combination air purifying device and ultraviolet illumination device of claim 10, wherein the mounting body of the air purifying device comprises a mounting plate, and wherein the mounting flange of the ultraviolet illumination device comprises a substantially planar surface connected substantially flush to the mounting plate over the at least one aperture of the air purifying device.

14. The combination air purifying device and ultraviolet illumination device of claim 10, wherein the at least one low-profile porous substrate is removably connected to the mounting body.

15. The combination air purifying device and ultraviolet illumination device of claim 10, wherein the mounting body comprises extending studs, and the mounting flange comprises apertures, and wherein the extending studs pass through the apertures for removably connecting the air purifying device to the ultraviolet illumination device.

16. A method of purifying air within an air handling system comprising:
providing an air purifying device comprising:
a mounting body which comprises a substantially planar surface and at least one aperture; and
at least one low-profile porous substrate, comprising a photocatalyst, connected to and extending from the mounting body; and
providing at least one ultraviolet illumination device comprising a mounting flange and an ultraviolet lamp connected to and extending from the mounting flange;
connecting the mounting body of the air purifying device to at least one of a duct and a plenum of an air handling system and positioning the low-profile porous substrate within an air flow path of the air handling system;
connecting the mounting flange of the at least one ultraviolet illumination device to the substantially planar surface of the mounting body of the air purifying device and passing the ultraviolet lamp through the at least one aperture within the air flow path of the air handling system;
providing a flow of air through the air flow path of the air handling system; and
illuminating the ultraviolet lamp.

17. The method of claim 16, further comprising:
providing the mounting body of the air purifying device with two apertures and providing the low-profile porous substrate as substantially planar;
providing the at least one ultraviolet illumination device as a first ultraviolet illumination device comprising a first ultraviolet lamp and a second ultraviolet illumination device comprising a second ultraviolet lamp; and
connecting the first ultraviolet illumination device and the second ultraviolet illumination device to the air purifying device with the first ultraviolet lamp and the second ultraviolet lamp approximately equidistant from the substantially planar low-profile porous substrate.

18. The method of claim 16, further comprising:
providing the at least one low-profile porous substrate as a first substantially planar porous substrate and a second substantially planar porous substrate, wherein the first substantially planar porous substrate and the second substantially planar porous substrate are approximately parallel; and
connecting the at least one ultraviolet illumination device to the air purifying device with the ultraviolet lamp extending through the at least one aperture between and approximately parallel with the first substantially planar porous substrate and the second substantially planar porous substrate.
